(19) United States
(12) Patent Application Publication
(10) Pub. No.: US 2014/0266219 A1
(43) Pub. Date: Sep. 18, 2014

(54) DETECTING ELECTROLYTE MENISCUS IN ELECTROPLATING PROCESSORS

(71) Applicant: APPLIED MATERIALS, INC., Santa Clara, CA (US)

(72) Inventors: Gregory J. Wilson, Kalispell, MT (US); Paul R. McHugh, Kalispell, MT (US); Daniel J. Woodruff, Kalispell, MT (US)

(73) Assignee: APPLIED Materials, Inc., Santa Clara, CA (US)

(21) Appl. No.: 13/827,953

(22) Filed: Mar. 14, 2013

(51) Int. Cl. G01N 17/02

(52) U.S. Cl. CPC G01N 17/02
USPC 324/425

(57) ABSTRACT

A detection fixture is provided with a processor for electroplating a substrate such as a semiconductor wafer, to detect the level of electrolyte in a bowl of the processor. The detected electrolyte level is used in controlling entry of the substrate into the electrolyte, to achieve desired electrolyte wetting characteristics. The processor has a substrate holder supported on a lifter for lowering the substrate holder into the bowl. The detection fixture may emulate a substrate and be held by the substrate holder in the same way that the substrate holder holds a substrate. The lifter lowers the detection fixture until it makes contact with the electrolyte, with the position of the fixture indicative the electrolyte level. The detection fixture is then removed from the processor.

### BACKGROUND OF THE INVENTION

The invention relates to electroplating substrates such as semiconductor wafers.

Microelectronic and other micro-scale devices are manufactured by processing a substrate such as a silicon wafer. An important processing step is electroplating a layer of metal onto the wafer. As device geometries become ever smaller, the method for moving the wafer into a bath of electrolyte or plating liquid, referred to here as wafer entry, becomes more important. Small variations in the wafer entry may cause electroplating defects on the wafer, which reduces the yield, or the number of good devices obtained from the wafer. Wafer entry into the electrolyte is accomplished using multiple axes of automation or robotic movement that can precisely control the speed, angle, position, and other parameters of wafer entry, as needed to achieve proper wetting interaction between the wafer surface and the electrolyte.

To consistently achieve a desired wafer entry requires knowing the position of the surface or meniscus of the electrolyte relative to the wafer. However, determining the position of the meniscus may be difficult due to dimensional tolerances between the mechanical components of the plating chamber and the automation, and the challenge of accurately and consistently measuring a fluid meniscus. Improved techniques are therefore needed in measuring the meniscus or free surface of electrolyte in electroplating substrates such as semiconductor wafers

### BRIEF DESCRIPTION OF THE DRAWINGS

In the drawings, the same element indicates the same element in each of the views.

FIG. 1 is a perspective view of an electroplating processor for electroplating substrates such as semiconductor wafers.

FIG. 2 is a perspective view of the bowl of the processor shown in FIG. 1.

FIG. 3 is a perspective view of a rotor which may be used in the processor shown in FIG. 1, and with a meniscus detection ring inserted partway into the rotor.

FIG. 4 is a perspective view of the rotor of FIG. 3 with the meniscus detection ring inserted fully into the rotor and ready for use.

FIG. 5 is a perspective section view of the detection ring shown in FIGS. 3 and 4.

FIG. 6 is an enlarged detail perspective view of the detector ring in the rotor as shown in FIG. 4.

FIG. 7 is a perspective view of the detector ring in use.

### DETAILED DESCRIPTION OF THE DRAWINGS

As shown in FIGS. 1 and 2, an electroplating processor 10 has a head 12 supported on a head lifter 14. The head lifter 14 may lift and lower the head, and also rotate or flip the head over, to move the head from a load/unload position to a processing position. Referring to FIGS. 1-3, the head 12 may have a contact ring 20 and a backing plate 24 on a rotor 18, for holding a wafer while also making electrical contact with the wafer, and optionally rotating the wafer in a bath of electrolyte held in the bowl 16. One or more anodes are provided in the bowl. Contact fingers 22 supported on turrets 50 on the contact ring 20 are electrically connected to a cathode. The cathode and anode may be reversed for de-plating operations.

In the past, one method for meniscus detection has been to slowly move a contact ring (with the wafer face-down) toward the electrolyte in the bowl. The meniscus position is then inferred by noting the head position at the point when electrical connection from the anodes to the cathode is detected. This is the position where electrolyte touches the ring contact/wafer assembly. The inventors have observed that the meniscus location detected by this method is not accurate enough for advanced plating applications because of the difficult-to-interpret wetting of the ring contact and wafer assembly. For example, the meniscus may touch an insulated portion of the ring contact (such as turret or other component on the ring contact) and wick up toward the wafer giving a meniscus detection signal as much as 2-4 mm before the wafer actually arrives at the meniscus position. Also, meniscus detection may occur when electrolyte touches exposed metal on a contact of the contact ring, which is also not at the elevation of the wafer.

Turning to FIGS. 3-6, the meniscus position may be detected using an electrically conductive detecting fixture 30 that takes the place of the wafer during the detection process. The fixture 30 may have a base 32, and a generally vertical ring section 38 optionally having a flat top surface 40, as shown in FIG. 5. The fixture 30 may be dimensioned so that it may be held into the head just like a wafer. For example, the fixture may have an outside diameter of 200, 300 or 450 mm, for use in processors designed to process these sizes of wafers. The fixture 30 may also have the same thickness as the wafer underneath the contacts 22 so that the deflection of the contacts 22 and the seal (if used) is replicated. For example, for a processor used for 300 mm diameter wafers having a nominal thickness of 0.775 mm, the outer flange 34 of the base 32 of the fixture 30 may have a thickness TT of 0.67 to 0.87 mm. Similarly, for a processor used for 450 mm diameter wafers having a nominal thickness of 0.925 mm, TT may be 0.82 to 1.00 mm. The height HH of the ring 38 as shown in FIG. 5 is great enough so that the ring 38 extends beyond the contact ring 20 and any of its components. For use in processors having a load/unload slot 26, HH is selected to allow sufficient clearance to move the fixture 30 through the slot.

At a radius inside of the contacts and seal, the ring 38 of the fixture 30 projects down beyond the contact ring 20. This insures that as the head 12 moves down towards the bowl, the electrolyte will make first contact with the ring 38. As a result, the meniscus position can be determined very precisely without the uncertainties of fluid wicking and exposed contacts.

FIGS. 3, 4 and 6 show the rotor 18 in the face up position. During processing, automation, such as a robotic end effector, may move a wafer through the load slot 26 in one side of the rotor 18. The lifter 14 may then flip the head and lower it towards the bowl 16, to perform the wafer entry steps. Measuring the meniscus of the electrolyte may be performed in a similar way, except that the fixture 30 is loaded into the rotor instead of a wafer. The fixture 30 may be loaded/unloaded from the rotor by automation or by hand.

FIG. 7 shows the rotor 18 in the processing position, as the fixture 30 is lowered into contact with the electrolyte 60 in the bowl 16, the ring 38 makes first contact with the electrolyte. Since the ring 38, or the flat surface 40 of the ring, is uniform, there is no wicking or other distortion in detecting the meniscus.

In an alternative design, the ring 30 could be provided as a complete solid disk rather than an annular ring. Use of an annular ring rather than a disk or plate reduces weight and material cost. The fixture ring 30 may have many different geometry shapes. For example, the protruding ring section 38 may be proporationally thicker or thinner than shown in the drawings. It may also have spaced apart protrusions such as a castellated wall. On the other hand the smooth continuous section 38 shown in the drawings is easily manufactured. The ring section 38 may be angled so that the radius at which the protrusion first touches the meniscus is altered. For example, if the base of the section 38 is at a radius of 146 mm in a 300 mm wafer diameter processor, then it is positioned inside of the contact finger radius. In this case, the ring section 38 may be angled outward so that the lowest extent of the wall (in the face-down orientation) is at 150 mm.

To detect when the center of the wafer first touches the meniscus (i.e. if the meniscus shape is significantly domed), a fixture 30 with a protruding electrically conductive bump, pin or other feature at the center of the fixture may be provided and operate in a similar way. The fixture 30 may be made of titanium or platinum plated titanium for electrolyte compatibility.

The detection of the meniscus can be performed in a flat orientation as shown in FIG. 7 or at the precise tilt angle of the wafer during the wafer entry. In the tilted orientation, the accuracy of motor encoder of the head lifter counts for wafer entry is likely improved, since any inaccuracies of the wafer/liquid being out of level for the orientation of FIG. 7 are avoided.

In another alternative embodiment, a contact ring having exposed regions of metal may be used to measure the first touch with the meniscus (rather than a separate fixture). If the offset between this “first touch” metal to the wafer is known, then the wafer position can similarly be determined. However, with use of the fixture 30 the existing contact ring 20 may remain in place and the deflection of the fingers is captured by using a fixture 30 having the same thickness as a wafer.

As will be apparent, the fixture 30 may be used with a variety of ring contact designs, and not just the wire ring with turrets. For example, the fixture 30 may be used with a 720 finger contact shielded contact ring, and with sealed contact rings.

Various changes and modifications may be made without departing from the spirit and scope of the invention. The invention, therefore, should not be limited, except by the following claims and their equivalents.

1. A processor for electroplating a substrate, comprising:
a bowl for holding electrolyte;
a substrate holder supported on a lifter for lowering the substrate holder into the bowl; and
a detection fixture held by the substrate holder for detecting a level of the electrolyte in the bowl, with the detection fixture removable from the substrate holder for processing a substrate, and the detection fixture having an annular surface facing the bowl, and with the annular surface closer to a surface of electrolyte in the bowl than the substrate holder.

2. The processor of claim 1 with the detection fixture comprising a ring on a base and the ring having a flat top surface.

3. The processor of claim 1 with the substrate holder comprising a contact ring having a plurality of contact fingers, and with the detection fixture having an outer flange inserted under the contact fingers.

4. The processor of claim 3 with the outer flange having a thickness of 0.6 to 1 mm.

5. The processor of claim 1 with the processor adapted for processing a substrate having an outer diameter OD, and with detection fixture having a outer diameter of OD+/−5%.

6. The processor of claim 1 with the substrate holder comprising a rotor, a contact ring on the rotor, and a plurality of finger contacts on the contact ring.

7. The processor of claim 1 with the annular surface of the detection fixture comprising a substantially uniform flat surface.

8. The processor of claim 1 with the substrate holder having a load/unload slot for loading and unloading a substrate into the substrate holder, and with the detection fixture loadable and unloadable into and out of the substrate holder via the load/unload slot.

9. The processor of claim 2 with the ring having at least one sidewall substantially perpendicular to the base.

10. The processor of claim 2 with ring having converging sidewalls.

11. A detection fixture for use in a processor for electroplating a substrate to determine a level of electrolyte in the processor, comprising:
an annular base having an outside diameter substantially equal to the substrate, with an outer perimeter of the annular base having a thickness substantially equal to the thickness of the substrate; and
a ring joined to or integral with the annular base and projecting out from the base.

12. A method for determining a level of electrolyte in a electroplating processor, comprising:
loading a detection fixture into a substrate holder of the electroplating processor;
lowering the substrate holder holding the detection fixture towards a bath of electrolyte in a bowl of the processor;
applying electrical potential to the electrolyte and to the detection fixture;
detecting an initial flow of electrical current between the electrolyte and the detection fixture; and
sensing a position of the substrate holder when the initial flow of electrical current is detected.

13. The method of claim 12 further comprising unloading the detection fixture from the substrate holder and loading a substrate into the substrate holder, without making any changes to the substrate holder.

14. The method of claim 12 with the substrate holder on a head supported by a lifter, and with no part of the head contacting the bowl.

15. The method of claim 12 further comprising rotating the substrate holder.

16. The method of claim 12 with the processor adapted to process a substrate having an outside diameter of OD and a thickness TT, and with the detection fixture having an outside diameter substantially equal to OD and a thickness substantially equal to TT.

17. The method of claim 12 further comprising lowering the substrate holder towards the bath of electrolyte with the substrate holder not parallel to the surface of the bath.
